(19) United States
(12) Patent Application Publication
(10) Pub. No.: US 2024/0281664 A1
(43) Pub. Date: Aug. 22, 2024

(54) System and Method for Optimized Training of a Neural Network Model for Data Extraction

(71) Applicant: Cognizant Technology Solutions India Pvt. Ltd., Chennai (IN)

(72) Inventors: Saravanan Radhakrishnan, Tiruvannamalai (IN); Rahul Agarwal, Kanpur (IN)

(21) Appl. No.: 18/136,985

(22) Filed: Apr. 20, 2023

(30) Foreign Application Priority Data
Feb. 16, 2023 (IN) 202341010420

(51) Int. Cl. G06N 3/09; G06N 3/0442

(52) U.S. Cl. CPC G06N 3/09; G06N 3/0442

(57) ABSTRACT

A system and method for optimized training of a neural network model for data extraction is provided. The present invention provides for generating a pre-determined format type of input document by extracting words from input document along with coordinates corresponding to each word. Further, N-grams are generated by analyzing neighboring words associated with entity text present in predetermined format type of document based on threshold measurement criterion and combining extracted neighboring words in pre-defined order. Further, generated N-grams are compared with coordinates corresponding to words for labelling N-grams with field name. Further, each word in N-gram identified by the field name is tokenized in accordance with location of each of the words relative to named entity (NE) for assigning token marker. Lastly, neural network model is trained based on tokenized words in N-gram identified by token marker. The trained neural network model is implemented for extracting data from documents.

### FIELD OF THE INVENTION

The present invention relates generally to the field of data extraction. More particularly, the present invention relates to a system and a method for optimized training of a neural network model for data extraction with increased accuracy.

### BACKGROUND OF THE INVENTION

Organizations around the world manage and process a huge inflow of documents every day for extracting and organizing information in a quick and meticulous manner. As such, an automated solution to manage and process documents in an effective and efficient manner is the need of the hour, particularly for semi-structured and unstructured documents in which information is arbitrarily positioned. Also, in the case of financial documents (e.g., invoices) even a small deviation may have a huge impact on credibility and authenticity. Moreover, financial documents entail a lot of variations in terms of templates and formats, contexts, and languages, and therefore requires constant adaptation. Documents do not often have fixed templates and, in fact, documents from same source have different structured layouts based on various aspects such as geography, domain, etc., which makes the data extraction challenging and tedious. For example, Value Added Tax (VAT) is used in Europe while Goods and Services Tax (GST) is used by other countries. Again, some fields in the documents, such as date may be represented differently by different organizations. Also, new fields may be added to existing set of fields, making processing of such dynamically altering documents challenging and error prone. Further, poor quality of documents makes it difficult to process the documents efficiently and effectively.

Further, processing semi-structured documents (such as, purchase order, credit memo, utility documents, contracts, etc.) is time consuming and wastes organization's resources. Document processing, if not carried out appropriately, may result in incorrect or delayed deliverables. Conventionally, template and rule-based document extraction processes are used which require continuous training and are therefore not efficient for future use. Additionally, new, and different types of documents may be added, and older document processing templates may be changed, which further provides challenges in document processing.

Further, existing rule-based techniques and template matching techniques for carrying out data extraction from documents are slow and inefficient. Rule based techniques may use a pre-populated dictionary for data extraction from the documents and it has been observed that the dictionary needs to be updated constantly, thereby further making the data extraction process error prone. Further, existing template matching techniques are inefficient as such techniques are not able to determine relationships between one or more text blocks used to extract data from documents, and do not consider features present at top and bottom in documents while handling sequences of features such as raw text, document page dimensions, positional and marginal features.

In light of the aforementioned drawbacks, there is a need for a system and a method which provides for optimized training of a neural network model for data extraction with increased accuracy. There is a need for a system and a method which provides for data extraction from different types of documents in an adequate and error-free manner. Furthermore, there is a need for a system and a method which provides for quick processing of documents for data extraction efficiently and effectively. Yet further, there is a need for a system for data extraction from provides and a method which documents in a cost-effective manner.

### SUMMARY OF THE INVENTION

In various embodiments of the present invention, a system for optimized training of a neural network model for data extraction is provided. The system comprising a memory storing program instructions, a processor executing instructions stored in the memory and a data extraction engine executed by the processor. The data extraction engine is configured to generate a pre-determined format type of an input document by extracting words from the input document along with coordinates corresponding to each word. The extracted words include entity text and neighboring words associated with the entity text. The data extraction engine is configured to generate N-grams by analyzing the neighboring words associated with the entity text present in the predetermined format type of the document based on a threshold measurement criterion and combining the extracted neighboring words in a pre-defined order. The data extraction engine is configured to compare the generated N-grams with the coordinates corresponding to the words for labelling the N-grams with a field name. Further, the data extraction engine is configured to tokenize each word in the N-gram identified by the field name in accordance with a location of each of the words relative to a named entity (NE) for assigning a token marker. Lastly, the data extraction engine is configured to train a neural network model based on the tokenized words in the N-gram identified by the token marker. The trained neural network model is implemented for extracting data from documents.

In various embodiments of the present invention, a method for optimized training of a neural network model for data extraction is provided. The method is implemented by the processor executing instructions stored in the memory. The method comprises generating a pre-determined format type of an input document by extracting words from the input document along with coordinates corresponding to each word. The extracted words include entity text and neighboring words associated with the entity text. The method comprises generating N-grams by analyzing the neighboring words associated with the entity text present in the predetermined format type of the document based on a threshold measurement criterion and combining the extracted neighboring words in a pre-defined order. The method comprises comparing the generated N-grams with the coordinates corresponding to the words for labelling the N-grams with a field name. Further, the method comprises tokenizing each word in the N-gram identified by the field name in accordance with a location of each of the words relative to a named entity (NE) for assigning a token marker. Lastly, the method comprises training a neural network model based on the tokenized words in the N-gram identified by the token marker. The trained neural network model is implemented for extracting data from documents.

In various embodiments of the present invention, a computer program product is provided. The computer program product comprising a non-transitory computer-readable medium having computer program code stored thereon, the computer-readable program code comprising instructions that, when executed by a processor, causes the processor to generate a pre-determined format type of an input document by extracting words from the input document along with coordinates corresponding to each word. The extracted words include entity text and neighboring words associated with the entity text. N-grams are generated by analyzing the neighboring words associated with the entity text present in the predetermined format type of the document based on a threshold measurement criterion and combining the extracted neighboring words in a pre-defined order. The generated N-grams are compared with the coordinates corresponding to the words for labelling the N-grams with a field name. Further, each word is tokenized in the N-gram identified by the field name in accordance with a location of each of the words relative to a named entity (NE) for assigning a token marker. Lastly, a neural network model is trained based on the tokenized words in the N-gram identified by the token marker. The trained neural network model is implemented for extracting data from documents.

### BRIEF DESCRIPTION OF THE ACCOMPANYING DRAWINGS

The present invention is described by way of embodiments illustrated in the accompanying drawings wherein:

FIG. 1 is a detailed block diagram of a system for optimized training of a neural network model for data extraction, in accordance with an embodiment of the present invention;

FIG. 2 illustrates generation of N-gram by combining extracted neighboring texts associated with entity text in a pre-defined order, in accordance with an embodiment of the present invention;

FIG. 3 illustrates a screenshot of a predetermined format type of document from which one or more entity text features are determined for generation of N-grams, in accordance with an embodiment of the present invention;

FIG. 4 illustrates determination of position-based features of entity text present in the document for recognizing position of the entity text in the document, in accordance with an embodiment of the present invention;

FIG. 5 illustrates a graphical representation depicting comparison of results of experiment nos. 1, 2, and 3, in accordance with an embodiment of the present invention;

FIG. 6 and FIG. 6A illustrate a flowchart depicting a method for optimized training of a neural network model for data extraction, in accordance with an embodiment of the present invention; and

FIG. 7 illustrates an exemplary computer system in which various embodiments of the present invention may be implemented.

### DETAILED DESCRIPTION OF THE INVENTION

The present invention discloses a system and a method which provides for optimized training of a neural network model for data extraction from documents in an effective and efficient manner. The present invention provides for a system and a method for extraction of relevant data from different types of documents in an adequate and error-free manner. Further, the present invention provides for reduced processing time of documents for data extraction in a cost-effective manner.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the scope of the invention. The terminology and phraseology used herein is for the purpose of describing exemplary embodiments and should not be considered limiting. Thus, the present invention is to be accorded the widest scope encompassing numerous alternatives, modifications, and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

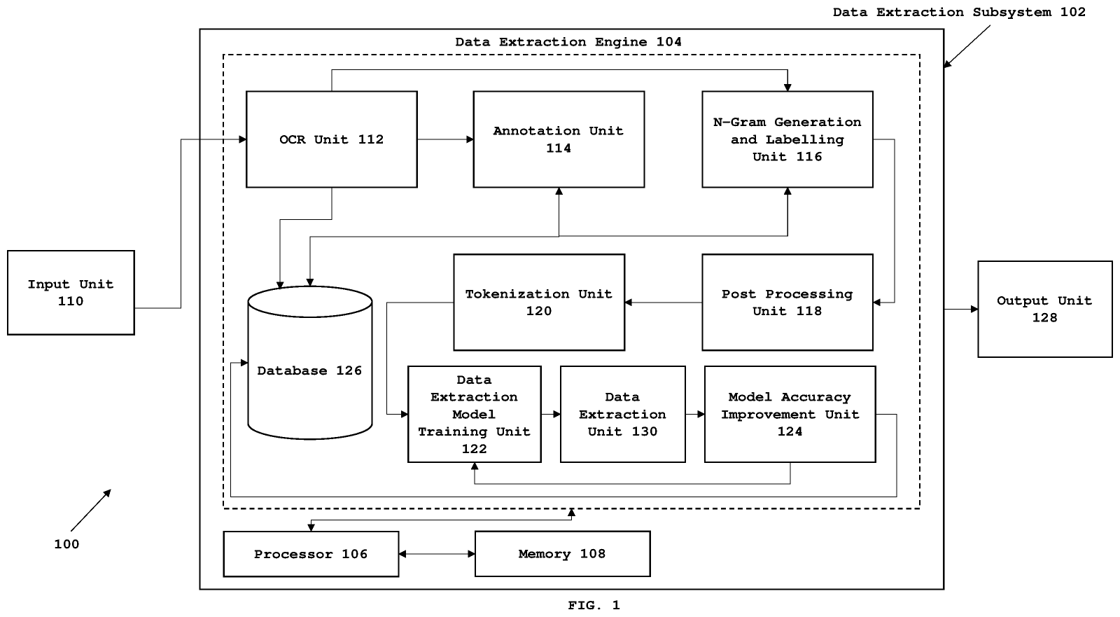

FIG. 1 is a detailed block diagram of a system 100 for optimized training of a neural network model for data extraction, in accordance with various embodiments of the present invention. Referring to FIG. 1, in an embodiment of the present invention, the system 100 comprises an input unit 110, a data extraction subsystem 102, and an output unit 128. The input unit 110 and the output unit 128 are connected to the subsystem 102 via a communication channel (not shown). The communication channel (not shown) may include, but is not limited to, a physical transmission medium, such as, a wire, or a logical connection over a multiplexed medium, such as, a radio channel in telecommunications and computer networking. Examples of radio channel in telecommunications and computer networking may include, but are not limited to, a local area network (LAN), a metropolitan area network (MAN) and a wide area network (WAN).

In an embodiment of the present invention, the subsystem 102 is configured with a built-in-mechanism for automatically extracting data from documents. The subsystem 102 is a self-optimizing and an intelligent system. In an exemplary embodiment of the present invention, the subsystem 102 employs cognitive techniques such as, but are not limited to, machine learning techniques, and deep learning techniques for automatically extracting data from documents.

In an embodiment of the present invention, the subsystem 102 comprises a data extraction engine 104 (engine 104), processor 106, and a memory 108. In various embodiments of the present invention, the engine 104 has multiple units which work in conjunction with each other for automatically extracting data from documents. The various units of the engine 104 are operated via the processor 106 specifically programmed to execute instructions stored in the memory 108 for executing respective functionalities of the units of the engine 104 in accordance with various embodiments of the present invention.

In another embodiment of the present invention, the subsystem 102 may be implemented in a cloud computing architecture in which data, applications, services, and other resources are stored and delivered through shared datacenters. In an exemplary embodiment of the present invention, the functionalities of the subsystem 102 are delivered to a user as Software as a Service (Saas) over a communication network.

In another embodiment of the present invention, the subsystem 102 may be implemented as a client-server architecture. In this embodiment of the present invention, a client terminal accesses a server hosting the subsystem 102 over a communication network. The client terminals may include but are not limited to a smart phone, a computer, a tablet, microcomputer or any other wired or wireless terminal. The server may be a centralized or a decentralized server.

In an embodiment of the present invention, the engine 104 comprises an Optical Character Recognition (OCR) unit 112, an annotation unit 114, an N-gram generation and labelling unit 116, a post processing unit 118, a tokenization unit 120, a data extraction model training unit 122, a model accuracy improvement unit 124, a database 126, and a data extraction unit 130.

In operation, in an embodiment of the present invention, one or more documents from which data is to be extracted are provided as input via the input unit 110. The input documents may be structured or semi-structured and are in a pre-defined format e.g., Portable Document Format (PDF), image format (e.g., .tiff, .jpeg, etc.), etc. The input unit 110 may be an electronic device (e.g., smartphone, printer, laptop, computer, etc.). The input documents from the input unit 110 are placed in a shared path and are transmitted to the OCR unit 112. In an embodiment of the present invention, the OCR unit 112 is configured to convert the input document into a predetermined format type. In an exemplary embodiment of the present invention, the predetermined format type is an XML file. The OCR unit 112 is configured to generate the predetermined format type of the document by extracting individual words from each page of the received documents and storing the extracted words in an XML format. In an exemplary embodiment of the present invention, the predetermined format type of the document (e.g., XML file) stores the extracted words as text along with coordinates corresponding to each extracted word in the received documents. The XML file also comprises features of the extracted words including, but are not limited to, confidence score, different text styles (e.g., bold, italics, etc.), height, width, etc. In an exemplary embodiment of the present invention, the confidence score is provided at character level. The OCR unit 110 stores the predetermined format type of the document in the database 126.

In an embodiment of the present invention, the annotation unit 114 is configured to receive the predetermined format type of the document from the OCR unit 112. The annotation unit 114 renders a Graphical User Interface (GUI), on the input unit 110 for carrying out an annotation operation on the predetermined format type of the document. In an exemplary embodiment of the present invention, the GUI is operated based on a GUI application. The annotation unit 114 renders the predetermined format type of the documents via the GUI. The annotation unit 114 generates annotation data by copying text from a relevant field in the predetermined format type or the pre-defined format of the document and selecting a text field corresponding to the relevant field for pasting the copied data by using a rubber band technique. The relevant field in the document is representative of various data values including, but are not limited to, document date, document number, client name, and amount. The rubber band technique is used to determine coordinates corresponding to the text field with the copied data, which is stored by the annotation unit 114 in the database 126.

In an embodiment of the present invention, the N-gram generation and labelling unit 116 is configured to receive the predetermined format type of the document from the OCR unit 112. The N-gram generation and labelling unit 116 is configured to process the predetermined format type of the document for generating N-grams.

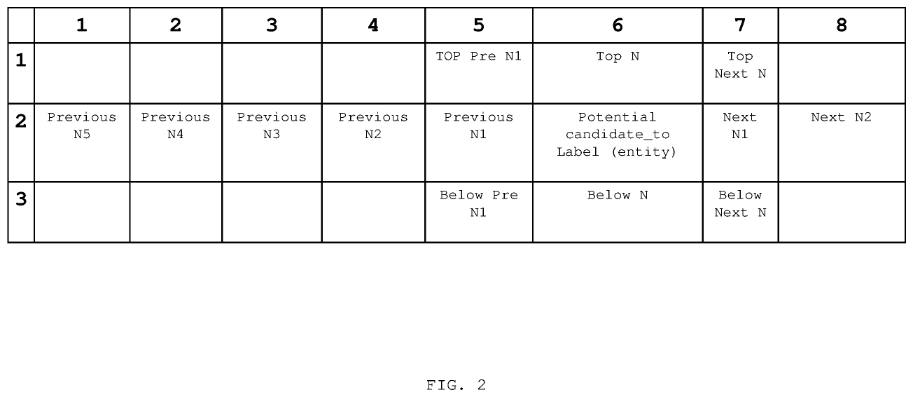

In an embodiment of the present invention, the N-gram generation and labelling unit 116 is configured to analyze the words stored in the predetermined format type of the documents and determine the words which are to be extracted, referred to as entity text hereinafter. The N-gram generation and labelling unit 116 determines the entity text by analyzing neighboring words corresponding to the entity text from left, top right and bottom of the entity text present in the predetermined format type for generating N-grams. The N-gram generation and labelling unit 116 analyzes the neighboring words of the entity text by applying a threshold distance measurement criterion from the entity text. In the event, it is determined that the neighboring words associated with the entity text are not available at the threshold distance from the entity text, then the threshold distance is changed to value −1 to avoid blank spaces between the neighboring words and entity text. In an exemplary embodiment of the present invention, the N-gram generation and labelling unit 116 extracts five neighboring words from the left of the entity text, three neighboring words from the top of the entity text, two neighboring words from right of the entity text, and three neighboring words from bottom of the entity text. The N-gram generation and labelling unit 116 then combines the extracted neighboring words associated with the entity text in a pre-defined order for generating N-grams, as illustrated in FIG. 2. Further, in another embodiment of the present invention, the annotation data is received by the N-gram generation and labelling unit 116 and is used for generation of N-grams. Table 1 illustrates description of the generated N-grams. The neighboring words associated with the entity text are further collected after analyzing N-grams for a large number of documents.

TABLE 1

| Name | Description |
|---|---|
| Position of entity | Position of entity in document like top-left, top- |
| | right, bottom-left, or bottom right |
| Is Bold | Whether entity is bold or not |
| Text Below | Text just below the entity |
| Entity | |
| Bottom | Text just below and right of the entity |
| Right | |
| Entity | |
| Bottom Left | Text just below and left of the entity |
| Entity | |
| Top Right | Text just above and right of the entity |
| Text | |
| Top Text | Text just above the entity |
| Top Left | Text just above and left of the entity |
| Text | |
| Left Text | 5 text word left of entity |
| Entity | Text |
| Right Text | 2 text word left of entity |

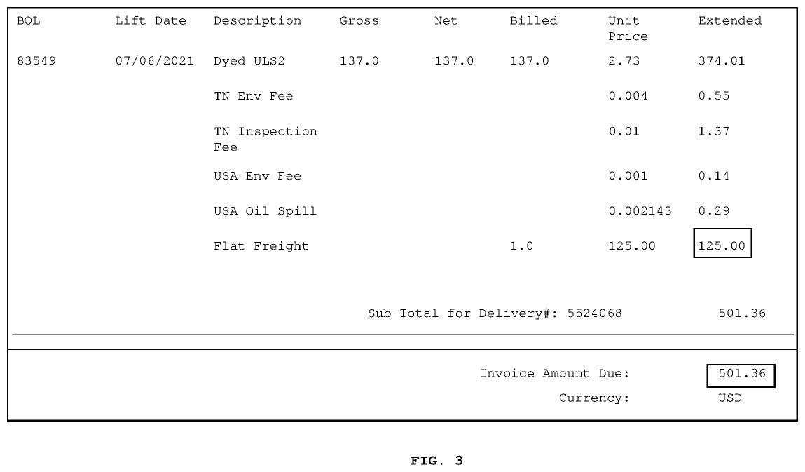

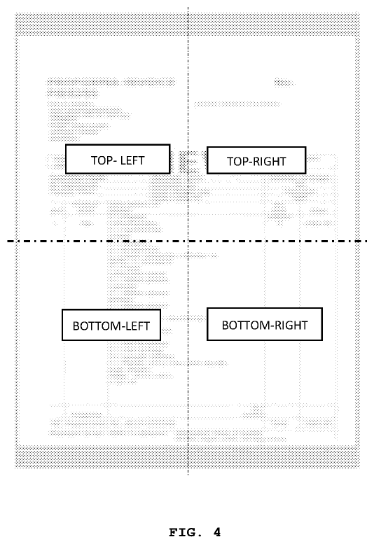

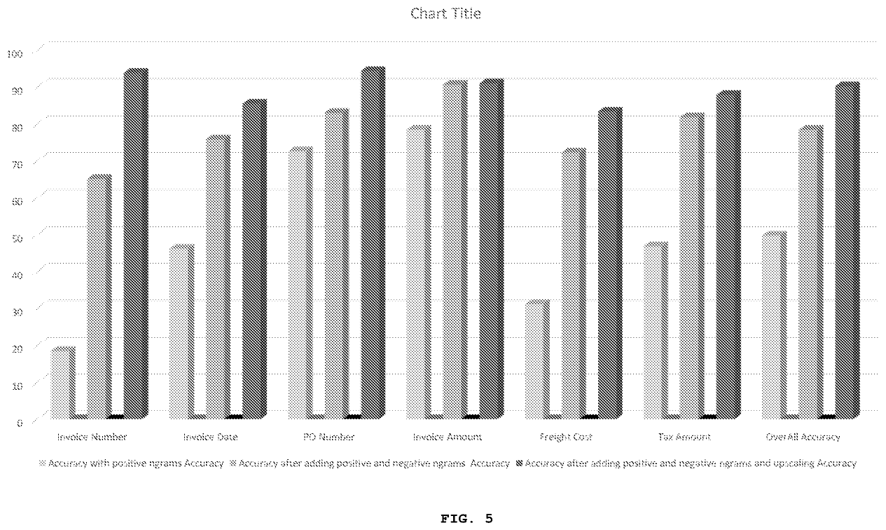

In an embodiment of the present invention, the N-gram generation and labelling unit 116 is configured to determine one or more entity text features from the pre-determined format type of the documents for generation of N-grams. The text features may include, but are not limited to, position of the entity text in the predetermined format type of the documents, and format of the entity text (e.g., bold or italics), as illustrated in FIG. 3. In an exemplary embodiment of the present invention, the position-based features of the entity text may include, but are not limited to, the entity text present at top-left of the document, the entity text present at top-right of the document, the entity text present at bottom-left of the document or the entity text present at bottom-right of the document, as illustrated in FIG. 4. Determining position-based features aids in efficiently recognizing position of the entity text in the document. For example, if the document is an invoice, then for differentiating actual invoice amount, words from below the text entity is considered by the N-gram generation and labelling unit 116 for N-gram generation.

In another embodiment of the present invention, the N-gram generation and labelling unit 116 is configured to label the generated N-grams by carrying out a matching operation. The matching operation is carried out by identifying the N-grams using a field value associated with a particular field in the predetermined format type document and one or more coordinates along with annotation data, which are stored in the database 126. Based on determination of a match, the N-gram generation and labelling unit 116 labels the N-grams with a field name. As such, the generated N-grams are compared with the coordinates corresponding to the words for labelling the N-grams with the field name. In the event, the entity text is present in more than one place, then the coordinates aids in identifying the entity text, without being dependent on field values. In an embodiment of the present invention, the N-gram generation and labelling unit 116 is configured to label all the unmatched N-grams as ‘others’.

In an embodiment of the present invention, subsequent to generation and labeling of N-grams, the post processing unit 118 is configured to further process the predetermined format type of the documents for converting all the numeric values present in the document to a machine-readable format. In an exemplary embodiment of the present invention, the numeric values are converted to a constant ‘x’. For example, the post processing unit 118 converts the numeric values ‘1234’ into ‘xxxx’, and the numeric value ‘IN-123’ is converted to ‘IN-xxx’. Further, the post processing unit 118 converts the date fields in the predetermined format type document to ‘dateval’ and all the amount fields are converted to ‘float’. Advantageously, replacing all the numeric values with the constant ‘x’ aids in significantly reducing variation in patterns of numeric values and aids in training the neural network model with higher accuracy.

In an embodiment of the present invention, the tokenization unit 120 is configured to process the generated and labelled N-grams for carrying out a tokenization operation. The tokenizing operation is carried out for tokenizing each N-gram and classifying each token with a token marker. In an exemplary embodiment of the present invention, the token marker is a ‘BIOLU’ tag. In an exemplary embodiment of the present invention, each word in the N-gram is tokenized for generating a tokenized word in accordance with its location relative to a named entity (NE). For example, a token marker ‘B’ is used for a first token of a NE, ‘I’ is used for tokens inside NE's, ‘O’ is used for tokens outside any NE, ‘L’ is used for the last tokens of NE's, and ‘U’ is used for unit length of NE's. Advantageously, tokenization is useful in a scenario when spaces are present in between field values, such that the named entity in the N-gram are analyzed without any error. For example, if the named entity in the document is 16 Dec. 2021, then during tokenization it is considered as three different words and are tokenized using the BIOLU tag.

In an embodiment of the present invention, the data extraction model training unit 122 is configured to receive the tokenized words from the tokenization unit 120 to build a neural network model. In an exemplary embodiment of the present invention, the data extraction model training unit 122 employs a keras library to train a recurrent neural network model based on bi-directional Long Short-term Memory (bi-LSTM) technique. The data extraction model training unit 122 converts the tokenized words in the N-gram into sequences and each tokenized word is assigned an integer. The data extraction model training unit 122 is configured to pad the sequence such that each tokenized word is of same length. The padded sequence of words is then used as an input for training the neural network model for data extraction. In an exemplary embodiment of the present invention, the data extraction model training unit 122 implements one or more techniques including, but are not limited to, embedding, dense dropout, LSTM, bidirectional layers from keras library for training the neural network model. In an embodiment of the present invention, subsequent to the training, the neural network model is employed by the data extraction unit 130 for extracting data from the predetermined format type of the documents.

In an embodiment of the present invention, the model accuracy improvement unit 124 is configured to communicate with the data extraction model training unit 122 for improving accuracy of the neural network model in order to effectively extract data from documents. The model accuracy improvement unit 124 is further configured to receive inputs, relating to the extracted data, from the data extraction unit 130 for improving accuracy of the neural network model. In an embodiment of the present invention, the model accuracy improvement unit 124 is configured to generate negative N-grams by carrying out a comparison operation. The model accuracy improvement unit 124 is configured to extract data fields present in the predetermined format type of the document using the trained neural network model and compare the extracted data fields with the annotated data stored in the database 126. In the event, it is determined that field values associated with the data fields do not match with the annotated data, then the N-grams that are generated are negative N-grams and are labelled as ‘others’. One or more criteria are employed for determining the match. The criteria may include firstly, determining distance between the extracted fields and annotated data and if the distance is minimal or within a pre-defined threshold, then the N-grams are not labelled as ‘others’. Advantageously, determining distance between the extracted fields and annotated data aids in correct labelling in the event of an OCR error or error while carrying out annotations. Secondly, if one or more keywords associated with the fields in the document are present in negative N-grams, then such N-grams are not considered as ‘others’, thereby avoiding any positive N-grams being labelled as ‘others’. In an embodiment of the present invention, the model accuracy improvement unit is configured to up-scale the generated N-grams for each field except for N-grams labelled as ‘others’. Advantageously, upscaling of the N-grams eliminates imbalance in the N-grams and increases accuracy of the neural network model.

In an embodiment of the present invention, the model accuracy improvement unit 124 is configured to determine a confidence score for the field values present in the document, based on predictions made by the neural network model. In the event the neural network model predicts two or more values for a particular field in the document, then the model accuracy improvement unit 124 is configured to filter the values based on the confidence score. The model accuracy improvement unit 124 considers the values with maximum confidence score. For example, if neural network model predicts two values for invoice number in an invoice document, i.e., one value with confidence score of 998 and another value with confidence score of 628, then the value with 99% confidence score is considered by the model accuracy improvement unit 124.

In an embodiment of the present invention, the data extracted by the neural network model from the predetermined format type of the document determined format type of the document is rendered via a GUI on the output unit 128. The output unit 128 may be an electronic device (e.g., smartphone, laptop, computer, etc.). Illustrated herein below are experiments that were conducted to test accuracy in data extraction for training the neural network model and employing the neural network model by the data extraction subsystem 102 for data extraction, in accordance with various embodiments of the present invention:

### Experiment no. 1

A set of 3000 documents (e.g., invoices) were taken from different vendors. The documents were split into 80:20 ratio. The neural network model was trained on a total of 2400 documents out of the 3000 documents. The trained neural network model was tested on the remaining 600 documents. In this experiment, the neural network model was trained with positive N-grams generated from the documents. The accuracy of the neural network model was determined to be around 50%. Further, one or more junk values were also identified that were extracted for fields such as freight amount and tax amount which were not mandatory and were not present in all the documents. Results of experiment no. 1 are illustrated in Table 2.

TABLE 2

| | Total | | |
|---|---|---|---|
| | Matched | Total | |
| Field Name | Fields | Fields | Accuracy |
| Invoice | 111 | 600 | 18.50 |
| Number | | | |
| Invoice | 277 | 600 | 46.16 |
| Date | | | |
| PO Number | 415 | 572 | 72.55 |
| Invoice | 471 | 600 | 78.50 |
| Amount | | | |
| Freight | 129 | 415 | 31.08 |
| Cost | | | |
| Tax Amount | 277 | 591 | 46.87 |
| Overall | 1680 | 3378 | 49.73 |
| Accuracy | | | |

### Experiment no. 2

Negative N-grams were generated, and the neural network model was trained on a combination of positive and negative N-grams. It was found that the accuracy of the data extraction model increased to around 788. Results of experiment no. 2 are illustrated in Table 3.

TABLE 3

| | Total | | |
|---|---|---|---|
| Field | Matched | Total | |
| Name | Fields | Fields | Accuracy |
| Invoice | 391 | 600 | 65.16 |
| Number | | | |
| Invoice | 434 | 572 | 75.87 |
| Date | | | |
| PO Number | 406 | 489 | 83.02 |
| Invoice | 544 | 600 | 90.66 |
| Amount | | | |
| Freight | 120 | 166 | 72.28 |
| Cost | | | |
| Tax Amount | 249 | 305 | 81.63 |
| Overall | 2144 | 2732 | 78.47 |
| Accuracy | | | |

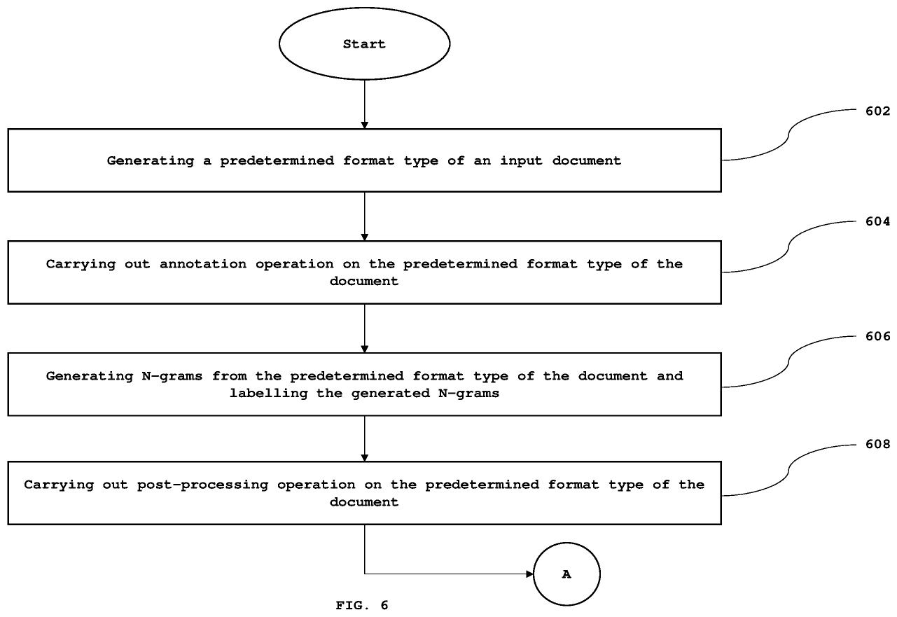

Further, it was observed that accuracy of the data extraction model was increased to around 90% when the positive N-grams were upscaled. Table 4 illustrates the accuracy achieved after adding positive and negative N-grams and upscaling of the positive N-grams. FIG. 5 illustrates a graphical representation depicting comparison of the results of experiment no. 1, 2, and 3.

TABLE 4

| | Total | | |
|---|---|---|---|
| | Matched | Total | |
| Field Name | Fields | Fields | Accuracy |
| Invoice | 563 | 600 | 93.83 |
| Number | | | |
| Invoice | 489 | 572 | 85.48 |
| Date | | | |
| PO Number | 461 | 489 | 94.27 |
| Invoice | 546 | 600 | 91.00 |
| Amount | | | |
| Freight | 138 | 166 | 83.13 |
| Cost | | | |
| Tax Amount | 268 | 305 | 87.87 |
| Overall | 2465 | 2732 | 90.23 |
| Accuracy | | | |

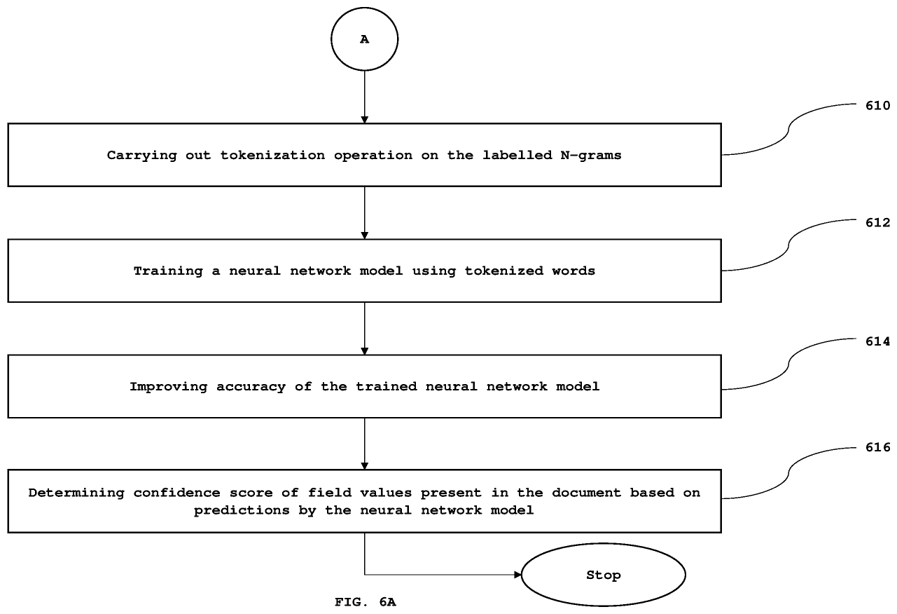

FIG. 6 and FIG. 6A illustrate a flowchart depicting a method for optimized training of a neural network model for data extraction, in accordance with various embodiments of the present invention.

At step 602, a predetermined format type of an input document is generated. In an embodiment of the present invention, one or more documents from which data is to be extracted are provided as input. Input documents are structured or semi-structured and are in a pre-defined format e.g., a Portable Document Format (PDF), or image format (e.g., .tiff, .jpeg, etc.). In an embodiment of the present invention, the input document is converted a into predetermined format type. In an exemplary embodiment of the present invention, the predetermined format type is an XML file. Individual words are extracted from each page of the received documents and the extracted words are stored in an XML format along with respective spatial coordinates and confidence score associated with the words present in the document.

At step 604, annotation operation is carried out on the predetermined format type of the document. In an embodiment of the present invention, the predetermined format type of the document is rendered via a GUI for carrying out the annotation operation on the predetermined format type or the pre-defined format of the document. The annotation operation is carried out by copying text from a relevant field and selecting a text field corresponding to the relevant field for pasting the copied data using a rubber band technique. The relevant field in the document is representative of various data values present in the document including, but not limited to, document date, document number, client name, and amount.

At step 606, N-grams are generated from the predetermined format type of the document and the generated N-grams are labelled. In an embodiment of the present invention, the N-grams are generated by analyzing words that need to be extracted from the predetermined format type of the document, referred to as entity text. Subsequently, neighboring words are determined corresponding to the entity text from left, top right and bottom of the entity text present in the predetermined format type for generating N-grams. The neighboring words of the entity text are analyzed by applying a threshold distance measurement technique. In the event, it is determined that the neighboring words associated with the entity text are not available at the threshold distance from the entity text, then the threshold distance is changed to value −1 to avoid blank spaces between the neighboring words and entity text. In an exemplary embodiment of the present invention, five neighboring words are extracted from the left of the entity text, three neighboring words from the top of the entity text, two neighboring words from right of the entity text, and three neighboring words from bottom of the entity text. The extracted neighboring words associated with an entity text are combined in a pre-defined order for generating N-grams. Further, in another embodiment of the present invention, the annotation data is used for generation of N-grams. Table 1 illustrates description of the generated N-grams. The neighboring texts associated with the entity text are further collected after analyzing N-grams for a large number of documents.

In an embodiment of the present invention, one or more entity text features are determined from the predetermined format type of the documents for generation of N-grams. The text features may include, but are not limited to, position of the entity text in the predetermined format type of the documents, and format of the entity text (e.g., bold or italics). In an exemplary embodiment of the present invention, the position-based features of the entity text include, the entity text present at top-left of the document, the entity text present at top-right of the document, the entity text present at bottom-left of the document or the entity text present at bottom-right of the document. For example, if the document s an invoice, then for differentiating actual invoice amount, words from below the text entity are considered for N-gram generation.

In another embodiment of the present invention, the generated N-grams are labelled by carrying out a matching operation. The matching operation is carried out by identifying a field value associated with the field and one or more stored coordinates along with annotation data. Thereafter, the N-grams are labelled with a field name. As such, the generated N-grams are compared with the coordinates corresponding to the words for labelling the N-grams with the field name. In an embodiment of the present invention, all the unmatched N-grams are labelled as ‘others’.

At step 608, a post-processing operation is carried out in the predetermined format type of the document. In an embodiment of the present invention, subsequent to labeling of N-grams all the numeric values present in the document are converted to a machine-readable format. In an exemplary embodiment of the present invention, the numeric values are converted to a constant ‘x’. For example, the numeric values ‘1234’ are converted into ‘xxxx’ and the numeric value ‘IN-123’ is converted to ‘IN-xxx’. The date fields in the document are converted to ‘dateval’ and all the amount fields are converted to ‘float’.

At step 610, tokenization operation is carried out on the labelled N-grams. In an embodiment of the present invention, the labelled N-grams are processed for carrying out tokenization operation for tokenizing each N-gram and classifying each token with a token marker. In an exemplary embodiment of the present invention, the token marker is a ‘BIOLU’ tag. In an exemplary embodiment of the present invention, each word in the N-gram is tokenized for generating a tokenized word in accordance with its location relative to a named entity (NE). For example, the token marker ‘B’ is used for a first token of a NE, ‘I’ is used for tokens inside NE's, ‘O’ is used for tokens outside any NE, ‘L’ is used for the last tokens of NE's, and ‘U’ is used for unit length of NE's.

At step 612, a neural network model is trained based on the tokenized words for data extraction. In an exemplary embodiment of the present invention, keras library is employed to train a recurrent neural network model based on bi-directional Long Short-Term memory (bi-LSTM) technique. The tokenized words in the N-gram are converted into sequences and each tokenized word is assigned an integer. Further, the sequence is padded such that each tokenized word is of same length. The padded sequence of words is then used as input for training the neural network model for data extraction. In an exemplary embodiment of the present invention, one or more techniques including, but are not limited to, embedding, dense dropout, LSTM, bidirectional layers from keras library are implemented for training the neural network model. Subsequent to the training, the neural network model is employed for extracting data from the predetermined format type of the documents.

At step 614, accuracy of the trained neural network model is improved. In an embodiment of the present invention, firstly negative N-grams are generated by carrying out a comparison operation. The data fields present in the documents are extracted using the trained neural network model and the extracted data fields are compared with the annotated data. In the event, it is determined that field values associated with the data fields do not match with the annotated data, then the N-grams that are generated are negative N-grams and are labelled as ‘others’. One or more criteria are employed for determining the match. The criteria may include firstly, determining distance between the extracted fields and annotated data and if the distance is minimal or within a pre-defined threshold, then the N-grams are not labelled as ‘others’. Secondly, if keywords associated with the fields in the document are present in negative N-grams, then such N-grams are not considered as ‘others’, thereby avoiding any positive N-grams being labelled as ‘others’. In an embodiment of the present invention, the generated N-grams are up-scaled for each field except for N-grams labelled as ‘others’.

At step 616, confidence score of field values present in the document is determined based on predictions by the neural network model. In an embodiment of the present invention, in the event the neural network model predicts two or more values for a particular field in the document, then the values are filtered based on the confidence score. The value with maximum confidence score is considered. For example, if the neural network model predicts two values for invoice number in an invoice document, i.e., one value with confidence score of 99% and another value with confidence score of 62%, then the value with 99% confidence score is considered. In an embodiment of the present invention, the result of the data extracted by the neural network model from the predetermined format type of the document is rendered via the GUI, along with the accuracy data.

Advantageously, in accordance with various embodiments of the present invention, the present invention provides for optimized training of a neural network model for extracting data from documents with enhanced accuracy. The present invention provides for automatically extracting relevant data from documents, thereby minimizing human intervention and manual effort. Further, the present invention provides for significantly reducing human errors that may occur during data extraction and also reduces efforts required from data operators. Furthermore, the present invention provides for quick processing of a large number of documents for data extraction along with increased accuracy.

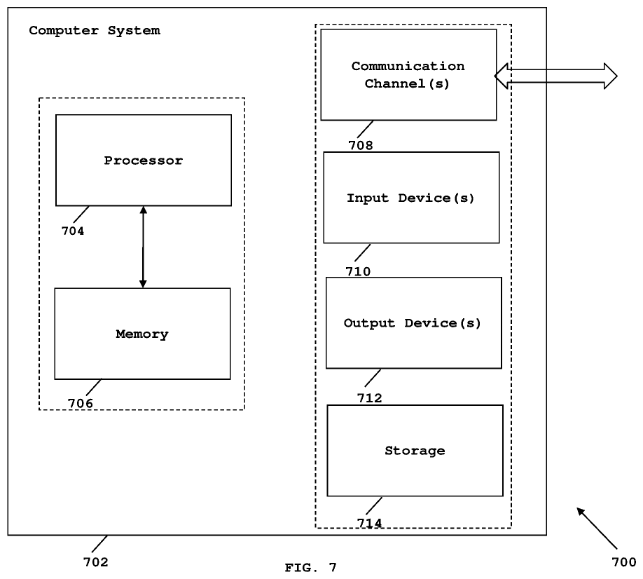

FIG. 7 illustrates an exemplary computer system in which various embodiments of the present invention may be implemented. The computer system 702 comprises a processor 704 and a memory 706. The processor 704 executes program instructions and is a real processor. The computer system 702 is not intended to suggest any limitation as to scope of use or functionality of described embodiments. For example, the computer system 702 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 706 may store software for implementing various embodiments of the present invention. The computer system 702 may have additional components. For example, the computer system 702 includes one or more communication channels 708, one or more input devices 710, one or more output devices 712, and storage 714. An interconnection mechanism (not shown) such a bus, controller, or network, interconnects the components of the computer system 702. In various embodiments of the present invention, operating system software (not shown) provides an operating environment for various softwares executing in the computer system 702 and manages different functionalities of the components of the computer system 702.

The communication channel (s) 708 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth, or other transmission media.

The input device (s) 710 may include, but not limited to, a keyboard, mouse, pen, joystick, trackball, a voice device, a scanning device, touch screen or any another device that is capable of providing input to the computer system 702. In an embodiment of the present invention, the input device (s) 710 may be a sound card or similar device that accepts audio input in analog or digital form. The output device (s) 712 may include, but not limited to, a user interface on CRT or LCD, printer, speaker, CD/DVD writer, or any other device that provides output from the computer system 702.

The storage 714 may include, but not limited to, magnetic disks, magnetic tapes, CD-ROMs, CD-RWs, DVDs, flash drives or any other medium which can be used to store information and can be accessed by the computer system 702. In various embodiments of the present invention, the storage 714 contains program instructions for implementing the described embodiments.

The present invention may suitably be embodied as a computer program product for use with the computer system 702. The method described herein is typically implemented as a computer program product, comprising a set of program instructions which is executed by the computer system 702 or any other similar device. The set of program instructions may be a series of computer readable codes stored on a tangible medium, such as a computer readable storage medium (storage 714), for example, diskette, CD-ROM, ROM, flash drives or hard disk, or transmittable to the computer system 702, via a modem or other interface device, over either a tangible medium, including but limited to optical or analogue not communications channel (s) 708. The implementation of the invention as a computer program product may be in an intangible form using wireless techniques, including but not limited to microwave, infrared, Bluetooth, or other transmission techniques. These instructions can be preloaded into a system or recorded on a storage medium such as a CD-ROM or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the scope of the invention.

We claim:

1. A system for optimized training of a neural network model for data extraction, the system comprising:
a memory storing program instructions;
a processor executing instructions stored in the memory; and
a data extraction engine executed by the processor and configured to:
generate a pre-determined format type of an input document by extracting words from the input document along with coordinates corresponding to each word, wherein the extracted words include entity text and neighboring words associated with the entity text;
generate N-grams by analyzing the neighboring words associated with the entity text present in the predetermined format type of the document based on a threshold measurement criterion and combining the extracted neighboring words in a pre-defined order;
compare the generated N-grams with the coordinates corresponding to the words for labelling the N-grams with a field name;
tokenize each word in the N-gram identified by the field name in accordance with a location of each of the words relative to a named entity (NE) for assigning a token marker; and
train a neural network model based on the tokenized words in the N-gram identified by the token marker, wherein the trained neural network model is implemented for extracting data from documents.

2. The system as claimed in claim 1, wherein the input document is a structured or a semi-structured document and is in a pre-defined format including a Portable Document Format (PDF), or an image format, and wherein the predetermined format type of the input document is an XML file.

3. The system as claimed in claim 1, wherein the data extraction engine comprises an annotation unit executed by the processor and configured to render a Graphical User Interface (GUI) via a input unit for carrying out an annotation operation on the predetermined format type of the document, and wherein the annotation unit generates annotation data by copying text from a relevant field in the predetermined format type or the pre-defined format of the document and selecting a text field corresponding to the relevant field for pasting the copied data by using a rubber band technique, and wherein the rubber band technique is used to determine coordinates corresponding to the text field with the copied data, which is stored by the annotation unit in a database, and wherein the annotation data is used for generation of N-grams.

4. The system as claimed in claim 1, wherein the data extraction engine comprises an N-gram generation and labelling unit executed by the processor and configured to determine entity text by analyzing neighboring words corresponding to the entity text from left, top right and bottom of the entity text present in the predetermined format type for generating N-grams, and wherein the neighboring words of the entity text are analyzed by applying a threshold distance measurement criterion from the entity text.

5. The system as claimed in claim 4, wherein the N-gram generation and labelling unit changes the threshold distance to value −1, in the event it is determined that the neighboring words associated with the entity text are not available at the threshold distance from the entity text, to avoid blank spaces between the neighboring words and entity text.

6. The system as claimed in claim 4, wherein the N-gram generation and labelling unit extracts five neighboring words from the left of the entity text, three neighboring words from the top of the entity text, two neighboring words from right of the entity text, and three neighboring words from bottom of the entity text.

7. The system as claimed in claim 4, wherein the N-gram generation and labelling unit is configured to determine one or more entity text features from the pre-determined format type of the documents for generation of N-grams, and wherein the text features include position of the entity text in the predetermined format type of the documents, and format of the entity text.

8. The system as claimed in claim 7, wherein the position-based features of the entity text include the entity text present at top-left of the document, the entity text present at top-right of the document, the entity text present at bottom-left of the document or the entity text present at bottom-right of the document.

9. The system as claimed in claim 1, wherein an N-gram generation and labelling unit is configured to label the generated N-grams by carrying out a matching operation, and wherein the matching operation is carried out by identifying the N-grams using a field value associated with a particular field in the predetermined format type document and the one or more coordinates along with annotation data, which are stored in the database.

10. The system as claimed in claim 9, wherein based on determination of a match, the N-gram generation and labelling unit labels the N-grams with a field name, and wherein the N-gram generation and labelling unit is configured to label all the unmatched N-grams as ‘others’.

11. The system as claimed in claim 1, wherein the data extraction engine comprises a post processing unit executed by the processor and configured to process the predetermined format type of the documents for converting all the numeric values present in the document to a machine-readable format.

12. The system as claimed in claim 1, wherein the data extraction engine comprises a tokenization unit executed by the processor and configured to process the generated and labelled N-grams for carrying out a tokenization operation for tokenizing each N-gram and classifying each token with the token marker.

13. The system as claimed in claim 1, wherein the data extraction engine comprises a data extraction model training unit executed by the processor and configured to receive the tokenized words from a tokenization unit to train the neural network model.

14. The system as claimed in claim 13, wherein the data extraction model training unit is configured to convert the tokenized words in the N-gram into sequences and each tokenized word is assigned an integer, and wherein the sequence is padded such that each tokenized word is of a same length, and wherein the padded sequence of words is used as an input for training the neural network model for data extraction.

15. The system as claimed in claim 1, wherein the data extraction engine comprises a model accuracy improvement unit executed by the processor and configured to communicate with a data extraction model training unit for improving accuracy of the neural network model in order to effectively extract data from documents, and wherein the model accuracy improvement unit is configured to receive inputs relating the extracted data from a data extraction unit for improving accuracy of the neural network model.

16. The system as claimed in claim 15, wherein the model accuracy improvement unit is configured to generate negative N-grams by carrying out a comparison operation with the annotation data, and wherein the model accuracy improvement unit is configured to extract data fields present in the predetermined format type of the document using the trained neural network model and compare the extracted data fields with the annotated data stored in the database.

17. The system as claimed in claim 16, wherein in the event the model accuracy improvement unit determines that field values associated with the data fields do not match with the annotated data, then the N-grams that are generated are determined as negative N-grams and are labelled as ‘others’, and wherein one or more criteria are employed for determining the match including determining if distance between extracted fields and annotated data is minimal or within a pre-defined threshold, then the N-grams are not labelled as ‘others’, and if one or more keywords associated with the fields in the document are present in negative N-grams, then such N-grams are not considered as ‘others’, thereby avoiding any positive N-grams being labelled as ‘others’, and wherein the model accuracy improvement unit is configured to up-scale the generated N-grams for each field except for N-grams labelled as ‘others’.

18. The system as claimed in claim 17, wherein the model accuracy improvement unit is configured to determine a confidence score for the field values present in the document based on predictions made by the neural network model, and wherein in the event the neural network model predicts two or more values for a particular field in the document, then the model accuracy improvement unit is configured to filter the values based on the confidence score, and wherein the model accuracy improvement unit considers the values with maximum confidence score.

19. A method for optimized training of a neural network model for data extraction, the method is implemented by the processor executing instructions stored in the memory, the method comprises:
generating a pre-determined format type of an input document by extracting words from the input document along with coordinates corresponding to each word, wherein the extracted words include entity text and neighboring words associated with the entity text;
generating N-grams by analyzing the neighboring words associated with the entity text present in the predetermined format type of the document based on a threshold measurement criterion and combining the extracted neighboring words in a pre-defined order;
comparing the generated N-grams with the coordinates corresponding to the words for labelling the N-grams with a field name;
tokenizing each word in the N-gram identified by the field name in accordance with a location of each of the words relative to a named entity (NE) for assigning a token marker; and
training a neural network model based on the tokenized words in the N-gram identified by the token marker, wherein the trained neural network model is implemented for extracting data from documents.

20. The method as claimed in claim 19, wherein a Graphical User Interface (GUI) is rendered for carrying out an annotation operation on the predetermined format type of the document, and wherein annotation data is generated by copying text from a relevant field in the predetermined format type or the pre-defined format of the document and selecting a text field corresponding to the relevant field for pasting the copied data by using a rubber band technique, and wherein the rubber band technique is used to determine coordinates corresponding to the text field with the copied data, and wherein annotation data is used for generation of N-grams.

21. The method as claimed in claim 20, wherein entity text is determined by analyzing neighboring words corresponding to the entity text from left, top right and bottom of the entity text present in the predetermined format type for generating N-grams, and wherein the neighboring words of the entity text are analyzed by applying a threshold distance measurement criterion from the entity text.

22. The method as claimed in claim 21, wherein in the event it is determined that the neighboring words associated with the entity text are not available at the threshold distance from the entity text, then the threshold distance is changed to value −1 to avoid blank spaces between the neighboring words and entity text.

23. The method as claimed in claim 22, wherein one or more entity text features are determined from the pre-determined format type of the documents for generation of N-grams, and wherein the text features include position of the entity text in the predetermined format type of the documents, and format of the entity text.

24. The method as claimed in claim 19, wherein the generated N-grams are labelled by carrying out a matching operation, and wherein the matching operation is carried out by identifying the N-grams using a field value associated with a particular field in the predetermined format type document.

25. The method as claimed in claim 24, wherein based on determination of a match, the N-grams are labelled with a field name, and wherein all the unmatched N-grams are labelled as ‘others’.

26. The method as claimed in claim 19, wherein the tokenized words in the N-gram are converted into sequences and each tokenized word is assigned an integer, and wherein the sequence is padded such that each tokenized word is of a same length, and wherein the padded sequence of words is used as an input for training the neural network model for data extraction.

27. The method as claimed in claim 24, wherein negative N-grams are generated by carrying out a comparison operation, and wherein data fields present in the predetermined format type of the document are extracted using the trained neural network model and compared with the annotated data.

28. The method as claimed in claim 27, wherein in the event it is determined that field values associated with the data fields do not match with the annotated data, then the N-grams that are generated are determined as negative N-grams and are labelled as ‘others’, and wherein one or more criteria are employed for determining the match including determining if distance between the extracted fields and annotated data is minimal or within a pre-defined threshold, then the N-grams are not labelled as ‘others’, and if one or more keywords associated with the fields in the document are present in negative N-grams, then such N-grams are not considered as ‘others’, thereby avoiding any positive N-grams being labelled as ‘others’, and wherein the generated N-grams are up-scaled for each field except for N-grams labelled as ‘others’.

29. A computer program product comprising:
a non-transitory computer-readable medium having computer program code stored thereon, the computer-readable program code comprising instructions that, when executed by a processor, causes the processor to:
generate a pre-determined format type of an input document by extracting words from the input document along with coordinates corresponding to each word, wherein the extracted words include entity text and neighboring words associated with the entity text;
generate N-grams by analyzing the neighboring words associated with the entity text present in the predetermined format type of the document based on a threshold measurement criterion and combining the extracted neighboring words in a pre-defined order;
compare the generated N-grams with the coordinates corresponding to the words for labelling the N-grams with a field name;
tokenize each word in the N-gram identified by the field name in accordance with a location of each of the words relative to a named entity (NE) for assigning a token marker; and
train a neural network model based on the tokenized words in the N-gram identified by the token marker, wherein the trained neural network model is implemented for extracting data from documents.
